(19) United States
(12) Patent Application Publication
(10) Pub. No.: US 2009/0310580 A1
(43) Pub. Date: Dec. 17, 2009

(54) WIRELESS COMMUNICATIONS APPARATUS

(75) Inventors: Ron Chapman, Victoria (AU); John Papageorgiu, Victoria (AU)

Correspondence Address: FOX ROTHSCHILD LLP;PRINCETON PIKE CORPORATE CENTER, 2000 Market Street, Tenth Floor, Philadelphia, PA, 19103, US

(73) Assignee: ASI ENTERTAINMENT INC., Melbourne, Victoria (AU)

(21) Appl. No.: 12/375,407

(22) PCT Filed: Jul. 16, 2007
(86) PCT No.: PCT/AU07/00986

§ 371 Date: May 1, 2009

(30) Foreign Application Priority Data
Jul. 27, 2006 (AU) 2006904050

(51) Int. Cl. H04W 84/12; H04W 4/00

(52) U.S. Cl. 370/338; 455/431

(57) ABSTRACT

An apparatus, method and system for enabling a portable electronic device (PED) (6), designed to operate on a cellular communications network, to operate on a Wi-Fi communications network, the PED (6) having: a transceiver for receiving and transmitting signals over the cellular communications network; and an auxiliary communications port, the apparatus including: an RF shield for preventing signals transmitted by the transceiver of the PED (6) from propagating into a surrounding environment; and a network interface (9) operatively connectable to the auxiliary communications port of the PED (6) and to the Wi-Fi communications network to enable the PED (6) to receive and transmit signals over the Wi-Fi communications network via the auxiliary communications port.

### FIELD OF THE INVENTION

The present invention relates to an apparatus, method and system for enabling a portable electronic device, designed to operate on a cellular communications network, such as GSM, CDMA, TDMA, GPRS, UMTS, EDGE, or W-CDMA network, to operate on a wireless LAN network. As the present invention is particularly suited for enabling a passenger on-board an aircraft to use their portable electronic device for communication during flight without interfering with the on-board electronic systems of the aircraft, it will be convenient to describe the invention in relation to that example application. It should however be understood that the invention is also suitable for other applications.

### BACKGROUND OF THE INVENTION

Portable electronic devices (PEDs), such as cellular phones and PDAs, are known to cause interference with aircraft navigation systems when used on aircraft. An aircraft's GPS receiver is particularly vulnerable to interference due to the close proximity to the frequency band used by GPS and PEDs operating on a cellular communications network such as GSM, CDMA and the like. In order to prevent interference occurring, commercial airlines request passengers onboard aircraft to have their cellular phones and PDAs turned off for the during of the flight.

A wireless local area network (WLAN) based upon IEEE802.11x, otherwise known as Wi-Fi, is certified for use on board aircraft as this network operates on a frequency band which does not interfere with aircraft navigational systems. Accordingly, laptop computers which are Wi-Fi enabled are therefore able to be used during a flight to facilitate access to the internet. Whereas, cellular phones and PDAs operating on cellular communications networks such as GSM and CDMA must not be operated for the duration of the flight.

It would be desirable to provide an apparatus, method and system which enables PEDs, such as cellular phones and PDAs, to operate over a communications network without interfering with aircraft navigation systems.

Any discussion of documents, devices, acts or knowledge in this specification is included to explain the context of the invention. It should not be taken as an admission that any of the material formed part of the prior art base or the common general knowledge in the relevant art in Australia, or any other country, on or before the priority date of the claims herein.

### SUMMARY OF THE INVENTION

In accordance with a first aspect of the invention there is provided an apparatus for enabling a portable electronic device (PED), designed to operate on a first communications network, to operate on a second communications network which is different to the first communications network, the PED having:

a transceiver for receiving and transmitting signals over the first communications network; and

an auxiliary communications port, the apparatus including:

an RF shield for inhibiting propagation of signals transmitted by the transceiver of the PED into a surrounding environment; and

a network interface operatively connectable to the auxiliary communications port of the PED and to the second communications network to enable the PED to receive and transmit signals over the second communications network via the auxiliary communications port.

The present invention advantageously enables a conventional PED, for example a cellular phone, to operate in an aircraft without interfering with on-board electronic systems. In this respect the RF shield inhibits the propagation of signal transmitted by the transceiver of the PED into the surrounding environment in the aircraft, whilst the network interface enables the PED to communicate in a manner which will not cause interference to the aircraft's on-board electronic systems. Accordingly, any passenger on the aircraft can use their personal PED, to which they are accustomed, to communicate during a flight.

The RF shield may be of any suitable form. Its function is to inhibit the propagation of RF signals into the surrounding environment, at least to the extent that those signals do not present a safety concern with respect to the aircraft electronic and navigation systems. The shield may therefore merely attenuate, or suppress, RF propagation, to the extent necessary, or it may entirely prevent propagation beyond the shield to the surrounding environment.

The RF shield may accordingly be provided in the form of a Faraday cage, having a metallic mesh with apertures sized to the targeted frequency range, or some equivalent thereof. For example, the shield may be made of a cloth or fabric which has been impregnated with a ferrite material, or it may be in the form of a paint layer which has similar properties. Other equivalent materials may also be used, as long as they serve to at least attenuate, suppresses or block propagation of the RF signals beyond the shield.

The network interface preferably includes a communications port via which the network interface can be wired to the auxiliary communications port to thereby enable the network interface to receive and transmit signals to the auxiliary communications port of the PED. The network interface may further include a first antenna via which the network interface can wirelessly receive and transmit signals to the auxiliary communications port of the PED. The network interface can also include a second antenna via which the network interface can receive and transmit signals over the second communications network.

The network interface may further include one or more microprocessors for formatting digital information in signals received from the auxiliary communications port, and digital information in signals received over the second communications network, to a format which can be transmitted over the second communications network and to the auxiliary communications port, respectively.

In accordance with a another aspect of the invention there is provided a method for enabling a portable electronic device (PED), designed to operate on a first communications network, to operate on a second communications network which is different to the first communications network, the PED having:

a transceiver for transmitting and receiving signals over the first communications network; and

an auxiliary communications port, the method including the steps of:

inhibiting propagation of signals transmitted by the transceiver of the PED into a surrounding environment by using an RF shield; and

receiving and transmitting signals over the second communications network with the PED via a network interface connected between the auxiliary communications port of the PED and the second communications network.

In accordance with yet another aspect of the invention there is provided a system for enabling a portable electronic device (PED), designed to operate on a first communications network, to operate on a second communications network which is different to the first communications network, the PED having:

a transceiver for receiving and transmitting signals over the first communications network; and

an auxiliary communications port, the system including:

an RF shield for inhibiting propagation of signals transmitted by the transceiver of the PED into a surrounding environment;

a base station for transmitting and receiving signals over the second communications network; and

a network interface operatively connectable to the auxiliary communications port of the PED and the base station to enable the PED to receive and transmit signals over the second communications network via the auxiliary communications port.

Preferably, the PED is a cellular phone, personal digital assistant (PDA) or the like. The auxiliary communications port of the PED is preferably a universal serial bus (USB), Bluetooth™ interface or the like.

In a preferred embodiment the first communications network is a cellular communications network. Preferably, the cellular communications network is a GSM or CDMA network. The second communications network is preferably a wireless local area network (WLAN). The WLAN is preferably based on IEEE 802.11x, otherwise known as Wi-Fi.

The RF shield preferably inhibits frequencies in the range of approximately 800 to 2400 MHz as this is the range of frequencies over which cellular devices normally operate. The RF shield is preferably shaped to enable the PED to be enclosed, at least in part, within the RF shield. In this regard, the RF shield can be a casing which is molded to conform to an exterior surface of the PED. In an alternative embodiment, the RF shield is in the form of a pouch that is relatively flexible and suitably sized to house within it any type of PED. In a further alternative, the pouch may be sized to generally conform with an exterior surface of a particular type of PED.

The network interface, otherwise referred to herein as a “communicator”, is preferably integrated into or mounted to the pouch and/or casing.

In accordance with a related invention there is provided an apparatus for enabling a portable electronic device (PED), designed to operate on a first communications network, to operate on a second communications network which is different to the first communications network, the PED having:

a transceiver for receiving and transmitting signals over the first communications network; and

an auxiliary communications port, the apparatus including:

a network interface operatively connectable to the auxiliary communications port of the PED and to the second communications network to enable the PED to receive and transmit signals over the second communication network via the auxiliary communications port.

The apparatus according to the related invention can be used when RF shielding is not required, for example, in a café where there is no risk of the PEDs RF emissions interfering with nearby electronic devices operating on a similar frequency band.

### BRIEF DESCRIPTION OF THE DRAWINGS

Further benefits and advantages of the present invention will become apparent from the following description of preferred embodiments of the invention. The preferred embodiments should not be considered as limiting any of the statements in the previous section. The preferred embodiments will be described with reference to the following figures in which:

FIG. 1 is a block diagram of the apparatus according to an embodiment of the invention;

FIG. 2 is a front view of a pouch, incorporating a RF shield, designed to enclose therein any type of PED, according to an embodiment of the invention;

FIG. 3 is a perspective view of a cellular phone housed within a casing, incorporating a RF Shield, moulded to conform with an exterior surface of the phone, according to another embodiment of the invention.

FIG. 4 is a block diagram of the apparatus according to another embodiment of the invention;

FIG. 5 is a perspective view of a cellular phone mounted in another type of pouch, according to a further embodiment of the invention;

FIG. 6 is a perspective view of a cellular phone housed within a pouch, and a communicator having a USB port, according to yet another embodiment of the invention.

### DESCRIPTION OF THE PREFERRED EMBODIMENTS

With reference to the accompanying figures there is shown a number of embodiments of an apparatus for enabling a portable electronic device (PED), such as a PDA or cellular phone, designed to operate on a cellular network, for example a GSM or CDMA network, to operate on a wireless LAN, such as IEEE802.11x, otherwise known as a Wi-Fi network.

The apparatus includes an RF shield which functions to inhibit radio frequencies which are normally emitted by a PED, when communicating over a cellular communications network, from propagating into the surrounding environment. In this regard, the RF shield may, in one embodiment of the invention, be in the form of a Faraday cage which includes a metallic mesh with apertures which are sized to prevent or attenuate radio frequencies of certain frequencies passing therethrough. In this embodiment the apertures may be sized such that the RF shield blocks, or at least suppresses the level of, radio frequencies in the range of approximately 800 to 2400 MHz passing therethrough. The radio frequencies inhibited by the RF shield are thus those used by PEDs to communicate over a cellular communications network.

In alternative embodiments, not shown in the drawings, the RF shield may be of an alternative form, such as a cloth, paint, or other material capable of inhibiting RF propagation.

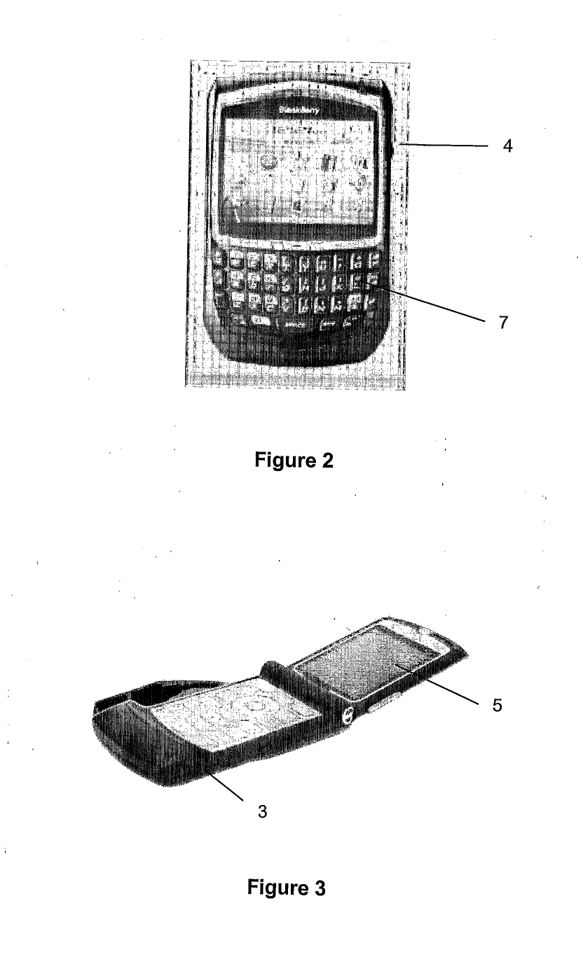

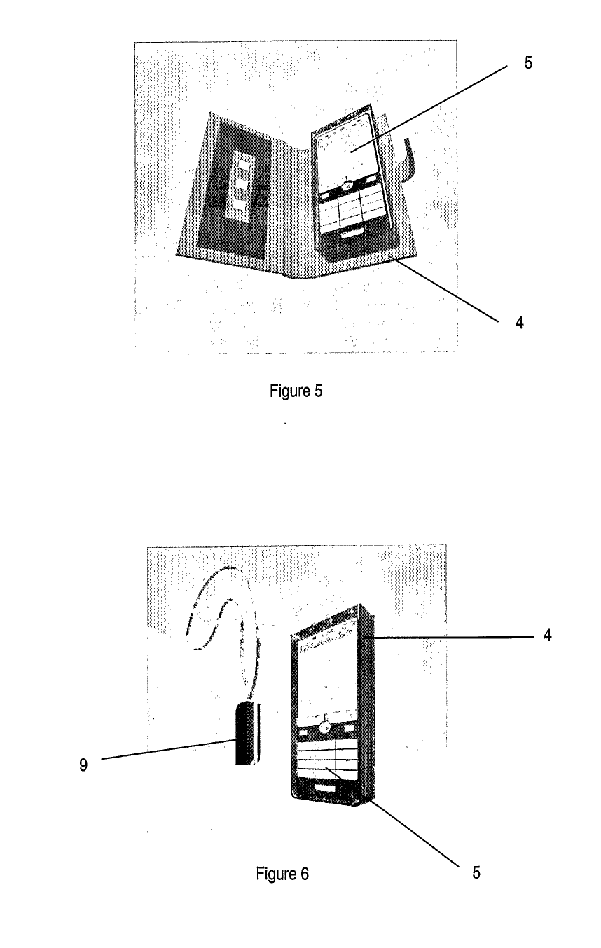

In a number of embodiments of the invention, the RF shield can preferably be in the form of a pouch 4, as shown in FIGS. 2, 5 and 6. The pouch 4 can be flexible and sized to accommodate therein any type of PED, for example a PDA 7, as shown in FIG. 2. Alternatively, the pouch 4 can be sized to more closely conform with an exterior surface of the PED. For example, the pouches 4 shown in FIGS. 5 and 6 are in the form of a travel pouch or wallet which can wrap around the PED being stored therein. In another embodiment, as shown in FIG. 3, the RF shield can be in the form of a casing 3 which is generally rigid and moulded to conform to an exterior of the PED. In FIGS. 3, 5 and 6 the PED shown is a cellular phone 5.

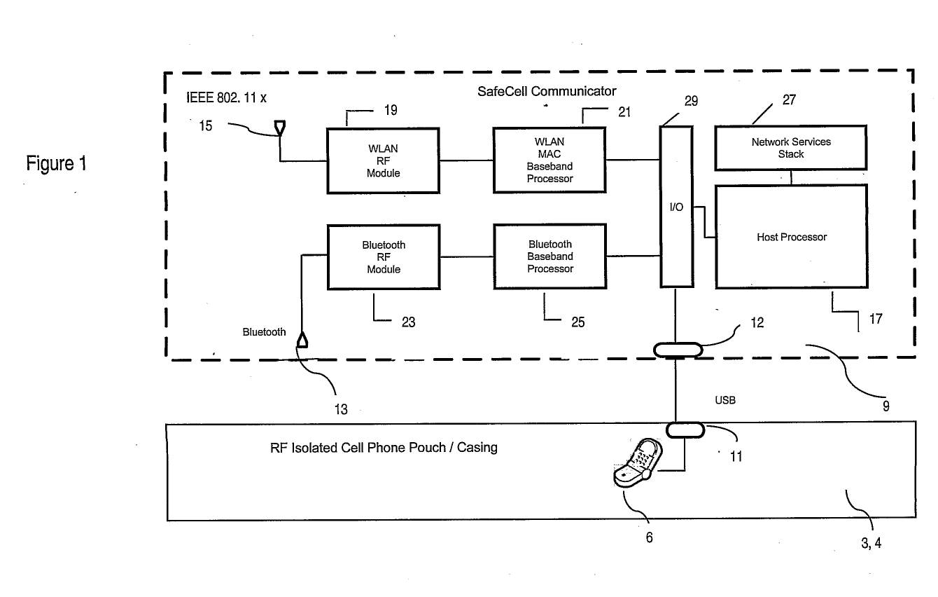

With reference to FIG. 1, the apparatus further includes a network interface, otherwise referred to herein as a communicator, 9. The communicator 9 can be operably connected to an auxiliary communications port of the PED 6. The auxiliary communications port of the PED 6 is preferably a USB port 11 which can be wired to a corresponding port 12 of the communicator 9. The communicator 9 may also include a first antenna 13 for enabling the communicator 9 to wirelessly receive and transmit signals to the auxiliary communications port of the PED 6 using a short-range wireless communications technology such as Bluetooth™. In order for the communicator 9 to communicate with the PED 6 using Bluetooth the PED 6 needs to be Bluetooth enabled with the auxiliary communications port being effectively a Bluetooth interface.

The communicator 9 further includes a second antenna 15 for enabling the communicator 9 to wirelessly receive and transmit signals over the second communications network. In this respect the second communications network is preferably a Wi-Fi network. The communicator 9 further includes one or more microprocessors 19, 21, 23, 25 for converting signals received by the communicator 9 to the appropriate protocol for transmission. In this respect, the communicator 9 formats digital information in a received signal from the PED 6 to a format which can be transmitted over the Wi-Fi network by converting the received signals to Wi-Fi protocols prior to transmission over the Wi-Fi network. Similarly, the communicator 9 formats digital information in a signal received from a base station in the Wi-Fi network to a format which can be transmitted via Bluetooth by converting the signal received to Bluetooth protocols prior to wireless transmission to the PED 6 via Bluetooth. In the event that the PED 6 is not Bluetooth enabled, digital information can be transmitted and received between the PED 6 and communicator 9 via an interface cable connected between the port 11 of the PED 6 and the corresponding port 12 of the communicator 9.

As mentioned earlier, Wi-Fi is certified for use on board aircraft as the network operates on a frequency band which does not interfere with the on-board electronic systems of aircraft. Accordingly Wi-Fi hot spots are provided in aircraft to enable passengers with PEDs 6 which have Wi-Fi capability to access the internet and VOIP. The present invention is particularly suited for application on board aircraft to provide a means by which passengers on board the aircraft can use their personal cellular phones during flight without interfering with the aircraft's operations. In this respect, the present invention enables a passenger's conventional cellular phone to obtain VOIP phone access, in addition to SMS and other data, via the WiFi hot spot in the aircraft.

The present invention advantageously allows the operation of a PED (PDA's, cell phones or the like) in-flight without requiring the use of a PicoCell or cellular network to transmit and receive the data. The present invention enables a PED to be used by passengers in-flight by outputting data via a USB port 11 or Bluetooth interface bridged to a Wi-Fi (IEEE 802.11x) network rather than GSM PicoCell frequencies. The pouch 4/casing 3 preferably encapsulates the PED 6 in an EMR isolating enclosure. The pouch 4/casing 3 is preferably in-part transparent to allow the use of the PED's keyboard/keypad and screen but at the same time inhibit the normal GSM/CDMA transmitting capability of the PED 6. The PED 6 can be interfaced via a Bluetooth interface or USB port 11 to an IEEE 802.11x (or Wi-Fi) transceiver of the communicator 9. The Wi-Fi transceiver may be located externally or internally of the pouch 4/casing 3 such that the PED 6 is thereby able to function for data services on an approved frequency.

There are currently three main types of PEDs. The first type is PDAs—personal computing device 7, incorporating a cell phone, e.g. a Blackberry. The second type is a cell phone 5 incorporating either a Bluetooth interface or USB port 11 or the like. The third type is the new generation cell phones and PDAs that incorporate a Wi-Fi interface.

Throughout the remainder of this specification the present invention will be referred to as “SafeCell”.

In order to enable a PED to operate via the Wi-Fi network a suitable software application is first installed on the PED. In this regard, the software can be downloaded from a website and installed. The user can then log into a relevant website, dial a telephone number or send an SMS to activate their account.

The software, depending on the operating system installed, may perform one of the following modes of operation:
Mode 1: Disables the PED's RF transmitter and routes all traffic (voice/SMS/data) to the auxiliary communications port.
Mode 2: Routes all traffic (voice/SMS/data) to the auxiliary communications port, for example the Bluetooth interface, even if the RF transmitter of the PED cannot be disabled.
Mode 3: Disables the PED's RF transmitter and routes only SMS to the auxiliary communications port.
Mode 4: Routes only SMS to the auxiliary communications port even if the RF transmitter of the PED cannot be disabled.

Further, the PED may be able to be controlled via the Wi-Fi network such that a command can be given prior to an aircraft landing and/or taking off to cause the PEDs on board to shut down.

The communicator 9 is preferably self-powered by internal batteries. The connection of the communicator 9 to the PED may be, for example, via:
USB: Compatible with USB 1.1 and USB 2.0.
COM: RS232 serial communication port
Bluetooth: Compatible with all Bluetooth versions, for example Bluetooth 1.2, Class 3 operation.

### Service Operability

Mode A: System offers proprietary messaging service.
Bi-directional SMS and email messaging.
No SIM authenticating required. Stand alone application.

Mode B: System offers full cell phone service support (i.e., voice/SMS/data).

### SafeCell Communicator 9 (Inflight Network Adapter)

The communicator 9 (USB/Bluetooth to Wi-Fi converter) can be either external or integrated into the structure of the RF shielded pouch 4/casing 5. With reference to FIG. 1 the communicator 9 consists of the following module blocks:
Host Processor block 17
Wi-Fi Communications block 19, 21
Example Hardware Implementation:
   AR5005UG chipset (2 chipset solution), which consists of:
      AR2112 radio-on-chip for 2.4 GHz WLAN+AR5523 Multi-protocol MAC/baseband processor
Bluetooth Communications block 23, 25
Example Hardware Implementation:
   AT76C551 single-chip Bluetooth controller
      The communicator 9 is designed to accommodate certification requirements of an in-flight Wi-Fi network. The system allows for the external control of passenger's PEDs from on-board the aircraft. This enables the facilitation of operations such as a “shut down” command during critical flight periods, for example during landing and take off, by aircraft personnel.

The present invention advantageously provides two mode operation (flight and ground) to allow access when on the ground to services via Wi-Fi hot spots, for example in airport terminals.

Flight Mode: The maximum transmission distance will always be short in flight mode as the user's PED will be in close proximity to the Wi-Fi base station in the aircraft. Therefore the maximum radiated power output and battery power consumption will be minimised.

Ground Mode: The wireless LAN transmission distance will be more consistent with conventional wireless LANs and therefore the maximum radiated power output should not be artificially constrained, up to the maximum allowable by the prevailing regulatory requirements for wireless LANs. This will proportionally affect the power consumption of the wireless LAN aspect of the “SafeCell” system.

The transmission distance, and hence radiated power/power consumption for the Bluetooth aspect of the “SafeCell” system will be unchanged from that exhibited during Flight Mode.

The communicator 9 is preferably designed for minimum wireless power output to facilitate maximum operating duration from the communicator's 9 internal batteries. Nominal wireless power output for 802.11x wireless LANs is 100 mW (EIRP). Since most PEDs on the market are capable of transmitting 100 meters using approx 500 mA at 5vDC (2.5 watts), a customised unit for transmission at, for example 6 meters to a leaky line antenna should see power demands come down significantly (down to mW levels). It may also be possible to have the PED directly power the communicator 9 depending upon the particular PED being used.

### WLAN RF Module 19

Uses 2.4 GHz ISM frequency band
11 Operation Channels
Receive Sensitivity (Typical, @BER 10⁻⁵): −83 dBm@11 Mbps
Nominal range 6 m
Nominal transmit power based on a maximum range of 6 m
Modulation Type:
   802.11b: Direct Sequence Spread Spectrum (CCK, DQPSK, DBPSK)
   802.11g: Orthogonal Frequency Division Multiplexing (64QAM, 16QAM, QPSK, BPSK)

### WLAN MAC Baseband Processor 21

Wi-Fi compliant with IEEE 802.11x
Dynamic Data Rate Scaling:
   11, 5.5, 2 and 1 Mbps for 802.11b
   54, 48, 36, 24, 18, 12, 9 and 6 Mbps for 802.11g
Supports 64/128/256-bit WEP and WPA encryption
Supports Infrastructure mode connections to Wi-Fi access points

### Bluetooth RF Module 23

Uses 2.4 GHz ISM frequency band
Class 3 operation (1 mW max transmit power, nominal maximum range required: 10 cm)
Note Class 3 Bluetooth operation allows for a nominal maximum range of 1 m. The constant very-close proximity of the Bluetooth antenna to a PED within the pouch means that the actual radiated transmit power is anticipated to be much less than the quoted maximum for Class 3 operation.

### Bluetooth Baseband Processor 25

Compliant with Bluetooth v1.2
Message transfer via OBEX protocol.
Data rate up to 732 Kbps
128-bit encryption

### Host Processor 17

Embedded 32-bit RISC microcontroller core that performs overall system control as well as implementing the Network Services Stack 27 used to provide the messaging service interface between the PED and the Wi-Fi network.
Provides USB Host functionality for direct connection to the PED's USB port (if used).

### I/O 29

Provides the system control/management interface between the Host Processor 17 and hardware peripheral interfaces connected to both the PED and the Wi-Fi network.
Provides the following interfaces:
   Up to 7 USB 2.0 Endpoints.
   All Endpoints support USB 2.0 full speed and low speed connections.
   Internal charge-pump provided for operation as USB Host.

### Network Services Stack 27

An Integrated set of software services used by the Host Processor 17 to provide high-level Wi-Fi message functions to a PED.
Implements the following network protocols:
   TCP/IP
   UDP
   ARP
   DHCP client
   SMTP
Provisions for implementing network services such as VOIP, WAP.
Implements wireless network side of “SafeCell” application software:
   Interfaces between cell-phone “SafeCell” application software and Wi-Fi network.
   Formats outbound SMS and email messages from PED for processing/delivery by Wi-Fi network services.

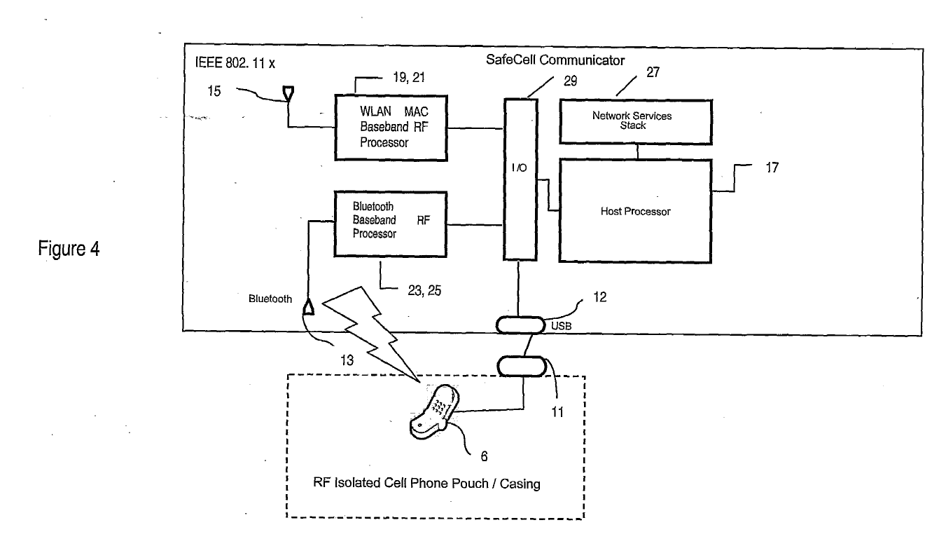

The communicator 9 shown in FIG. 4 is similar to that shown in FIG. 1. Like reference numerals to those in FIG. 1 are therefore used in FIG. 4 to represent equivalent components. In contrast to the communicator 9 in FIG. 1, the communicator in FIG. 4 only has one Wi-Fi communication block 19, 21 and one Bluetooth communication block 23, 25. Further, in FIG. 4 Wi-Fi and Bluetooth functionality is available on a single chip solution, for example as provided by the BCM4325 chip from Broadcom Corporation. In addition, the communicator 9 shown in FIG. 4 has a headset jack to enable an external headset having a microphone 31 and speaker 33 to facilitate VOIP without the user disturbing those nearby.

WLAN (Wi-Fi) functionality is available as a single chip solution (as used in FIG. 1), for example as provided by the AR6001GL chip from Atheros™ Communications. This chip has a ROC (Radio-On-Chip) platform targeted for embedded wireless devices. The AR6001GL integrates the RF transceiver, baseband, MAC, central processing and peripheral control functions. A separate RF front-end module is required to integrate the power amplifier, low-noise amplifier, and transmit/receive switch. A reference design is available that is 150 mm² x1.4 mm high. The AR6001GL includes WLAN firmware that facilitates the host/target communications layer for basic packetised message exchange between the host applications processor and the AR6001GL.

Bluetooth functionality is also available on a single chip platform (as used in FIG. 1), for example as provided by the SiW3500 chip from RFMD™ which combines radio transceiver, baseband processor and protocol stack. The SiW3500 also includes an integrated 50 ohm on-chip matching circuit.

As mentioned earlier, WLAN/Bluetooth functionality is also available on a single chip solution (as used in FIG. 4), for example as provided by the BCM4325 chip from Broadcom Corporation.

Host—Applications processor: There are a number of suitable processors that are specifically targeted for the wireless handset applications (PDA's, cell phones, etc). Some vendors such as the “ARM” technology feature prominently within these types of applications. Since the selected WLAN and Bluetooth solutions are SoC platforms, the requirements for interfacing to these devices is simplified allowing the application processor to focus with the task of performing the upper level network services. Examples of such suitable devices are the STR71xF family that integrates the following required capabilities:
32-Bit single chip microcontroller (targeted for embedded communications applications)
External memory interface
Integrated communication peripherals (1×SPI, 1×UART, 1×USB as minimum)
Low power saving modes
   “SafeCell” Mobile Application Software—Standalone application
Standalone PED application to incorporate the following operations:
   Generate a text message and send to the auxiliary port of the PED
   Ability to access the address book for phone numbers and email contacts
   Account activation and subscription service (i.e. keeps a record of prepaid usage)
   Note: In basic terms the software application may use the PED's user interface and address book to generate text based messages (email & SMS) and deliver them to the USB port (push to USB-based wireless device)
Provides ability to disable RF module (transmitter in particular), for compatible PED architectures.
Implementations for Java PED architectures.
Can be installed into PED using conventional mobile program download mechanisms.
Provision for implementing “SafeCell” application software as Wi-Fi network server-side web pages delivered as WAP to normal PED browser. Explicit downloading of application software to PED would not be required for this option.

The present invention advantageously enables passengers on-board an aircraft to use their personal PED without interfering with the aircraft's electrics. In addition, the present invention addresses the safety concerns of spurious EMR being emitted from PEDs that are carried on-board by passengers. Irrespective of whether PED is switched on or off the pouch/casing having the RF shield therein will prevent unintentional EMR emissions from a PED stored within the pouch/casing. Accordingly, the present invention addresses the aviation industries concerns regarding the use of PED by passengers on aircraft.

As the present invention may be embodied in several forms without departing from the essential characteristics of the invention, it should be understood that the above described embodiments should not be considered to limit the present invention but rather should be construed broadly. Various modifications and equivalent arrangements are intended to be included within the spirit and scope of the invention. Whilst the invention has been described in relation to its use in aircraft it should not be considered as limiting the invention to only that example application.

1. An apparatus for enabling a portable electronic device (PED), designed to operate on a cellular communications network, to instead operate on a wireless local area network on-board an aircraft, the PED having:
a transceiver for receiving and transmitting signals over the cellular communications network; and
an auxiliary communications port, the apparatus including:
an RF shield for inhibiting propagation of signals, transmitted by the transceiver of the PED, over the cellular communications network; and
a network interface operatively connectable to the auxiliary communications port of the PED and to the wireless local area network to enable the PED to receive and transmit signals, over the wireless local area network via the auxiliary communications port, without interfering with on-board electronic systems of the aircraft.

2. An apparatus as claimed in claim 1 wherein the network interface includes a communications port via which the network interface can be wired to the auxiliary communications port to thereby enable the network interface to receive and transmit signals to the auxiliary communications port of the PED.

3. An apparatus as claimed in claim 1 wherein the network interface further includes a first antenna via which the network interface can wirelessly receive and transmit signals to the auxiliary communications port of the PED.

4. An apparatus as claimed in claim 3 wherein the network interface includes a second antenna via which the network interface can receive and transmit signals over the wireless local area network.

5. An apparatus as claimed in claim 1 wherein the network interface further includes one or more microprocessors for formatting digital information in signals received from the auxiliary communications port, and digital information in signals received over the wireless local area network, to a format which can be transmitted over the wireless local area network and to the auxiliary communications port, respectively.

6-7. (canceled)

8. An apparatus as claimed in claim 1 wherein the RF shield prevents frequencies in the range of approximately 800 to 2400 MHz from propagating into the surrounding environment.

9. An apparatus as claimed in claim 1 wherein the RF shield forms a casing for storing the PED therein.

10. An apparatus as claimed in claim 7 wherein the casing is moulded to conform to an exterior surface of the PED.

11. An apparatus as claimed in claim 7 wherein the network interface is mounted to the casing.

12. An apparatus as claimed in claim 1 wherein the RF shield forms a pouch for storing the PED therein.

13. An apparatus as claimed in claim 10 wherein the network interface is mounted to the pouch.

14. A method for enabling a portable electronic device (PED), designed to operate on a cellular communications network, to instead operate on a wireless local area network on-board an aircraft, the PED having:
a transceiver for transmitting and receiving signals over the cellular communications network; and
an auxiliary communications port, the method including the steps of:
inhibiting propagation of signals, transmitted by the transceiver of the PED over the cellular communications network, by using an RF shield; and
receiving and transmitting signals, over the wireless local area network with the PED via a network interface connected between the auxiliary communications port of the PED and the wireless local area network, without interfering with on-board electronic systems of the aircraft.

15. A system for enabling a portable electronic device (PED), designed to operate on a cellular communications network, to instead operate on a wireless local area network on-board an aircraft, the PED having:
a transceiver for receiving and transmitting signals over the cellular communications network; and
an auxiliary communications port, the system including:
an RF shield for inhibiting propagation of signals, transmitted by the transceiver of the PED, over the cellular communications network;
a base station for transmitting and receiving signals over the wireless local area network; and
a network interface operatively connectable to the auxiliary communications port of the PED and the base station to enable the PED to receive and transmit signals, over the wireless local area network via the auxiliary communications port, without interfering with on-board electronic systems of the aircraft.
